(19) United States
(12) Patent Application Publication
(10) Pub. No.: US 2006/0004668 A1
(43) Pub. Date: Jan. 5, 2006

(54) Method of distributing electronic license keys

(76) Inventors: Jan Hakan Hamnen, Kallered (SE); Vidar Nicolaysen, Oslo (NO)

Correspondence Address: ERICSSON INC., 6300 LEGACY DRIVE, M/S EVR C11, PLANO, TX, 75024, US

(21) Appl. No.: 10/883,138

(22) Filed: Jul. 1, 2004

(51) Int. Cl. G06F 17/60

(52) U.S. Cl. 705/59

(57) ABSTRACT

A method of distributing to a plurality of computer appliances, an electronic license key that enables the appliance to access protected software. A selling party sends “license tokens” to a user. Each token enables the user to load a license key on one of the user's appliances. Tokens may be forwarded by the user for loading license keys onto other appliances. Tokens may be loaded onto a portable laptop computer, which can then be connected to “off-line” appliances in order to load license keys onto appliances that are not connected to a network through which the electronic license key can be downloaded.

### BACKGROUND

The present invention relates to computer processing systems. More particularly, and not by way of limitation, the present invention is directed to a method of efficiently ordering and distributing a plurality of electronic license keys.

The rapid development of modern computer processors has resulted in hardware platforms capable of performing many different functions. Therefore in many computer appliances, the functionality available to the user depends, not on the hardware itself, but on which software has been enabled or loaded into the hardware. A common business model for such appliances uses licensing, whereby electronic license keys are used to access protected portions of the software that provide specific product functionality, features, or content that is not otherwise enabled. Such license keys enable the specific functionality, features, or content to be utilized in an identified user appliance. The appliance is identified by a “fingerprint”, for example its serial number, which is included (often encrypted) as a part of the electronic key, thereby preventing fraudulent usage.

FIG. 1 is an illustrative drawing of an existing method of distributing electronic license keys. Existing license management schemes are based on transferring a certain right-to-use from a Selling Party 11 to a single purchaser for use on a single computer appliance. In other words, the selling party provides the license keys to enable a function in one particular appliance belonging to the purchaser. As shown in FIG. 1, the Selling Party 11 supplies individual license keys over the Internet 12 to a number of on-line appliances (App-1 through App N) 13-15 belonging to Purchaser-A. An additional complication in existing license management schemes arises when the appliance to be licensed is not on-line connected with the purchaser. In such cases, the supplier must provide the electronic license key to the purchaser, and the purchaser must enter the encrypted key string. This may be done manually by typing in the string, or the string may be supplied on a diskette, which the purchaser loads on his appliance. In FIG. 1, a manually loaded license key is supplied for “off-line” appliance (OL-App-1) 16. The purchaser may also have to locate the fingerprint information for the appliance before ordering the electronic license key from the supplier.

Thus, in a time-consuming and problematic process, an individual license key must be ordered for each individual appliance and distributed from the Selling Party to each individual appliance. This results in complex and problematic administration when there are a large number of appliances, either because there are a large number of purchasers or because individual purchasers have a large number of appliances. Additional complexity and problems arise when the ordering and supply chain is more complex, for example, when there is a distributor in between the Selling Party and the end user/purchaser. Again this is a time-consuming and problematic process when large numbers of appliances are involved.

It would be advantageous to have a method of efficiently ordering and distributing a plurality of electronic license keys that overcomes the disadvantages of existing methods. The present invention provides such a method.

### SUMMARY

In one aspect, the present invention is directed to a method of distributing an electronic license key from a selling party to a plurality of computer appliances, wherein loading the electronic license key on an appliance enables the appliance to access a protected software portion. The method includes the steps of distributing a plurality of license tokens from the selling party to a user having a plurality of computer appliances that require the electronic license key, wherein each license token enables the user to load the electronic license key onto one of the computer appliances; and loading the electronic license key by the user onto a plurality of computer appliances.

In another aspect, the present invention is directed to a method of distributing an electronic license key to a plurality of computer appliances. The method includes the steps of receiving by a distributor, a plurality of license tokens distributed by a selling party, wherein each license token enables an end-user to load the electronic license key onto one of the end-user's computer appliances; and sending at least one license token from the distributor to a first end-user.

In yet another aspect, the present invention is directed to a method of distributing an electronic license key from a selling party to a plurality of computer appliances. The method includes the steps of sending a plurality of license tokens from the selling party to a user having a plurality of computer appliances that require the electronic license key, wherein each license token enables the user to load the electronic license key onto one of the computer appliances; receiving the plurality of license tokens in a first part of the user's organization; and dividing the plurality of license tokens received by the user into a first subset and a second subset. The method also includes loading the electronic license key onto a number of computer appliances within the first part of the user's organization that is equal to or less than the number of license tokens in the first subset; forwarding the second subset of license tokens from the first part of the user's organization to a second part of the user's organization; and loading the electronic license key onto a number of computer appliances within the second part of the user's organization that is equal to or less than the number of license tokens in the second subset. When one of the user's computer appliances is an off-line appliance that is not connected to a network through which the electronic license key can be downloaded, the method also includes loading a license token on a portable appliance; connecting the portable appliance to the off-line appliance; and loading the electronic license key onto the off-line appliance from the portable appliance.

In still yet another aspect, the present invention is directed to a method of distributing an electronic license key from a selling party to a plurality of computer appliances. The method includes the steps of creating a license token that provides a user with a right to load the electronic license key onto the plurality of computer appliances; and distributing the license token from the selling party to the user.

In still yet another aspect, the present invention is directed to a method of distributing a plurality of electronic license keys from a selling party to a user having at least one computer appliance, wherein each electronic license key enables the appliance to access a different protected software feature. The method includes the steps of creating a license token that provides the user with a right to load the plurality of electronic license keys onto the at least one computer appliance; and distributing the license token from the selling party to the user. The license token may enable the user to pass on the license token to a specified number of other users, and may enable the user to pass on a license token that provides another user with the right to load only a selected license key onto a computer appliance.

### BRIEF DESCRIPTION OF THE SEVERAL VIEWS OF THE DRAWINGS

In the following section, the invention will be described with reference to exemplary embodiments illustrated in the figures, in which:

FIG. 1 (Prior Art) is an illustrative drawing of the existing method of distributing electronic license keys; and

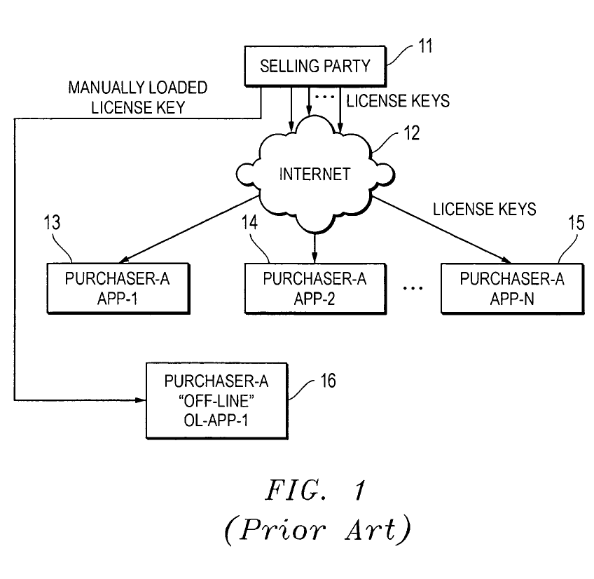

FIG. 2 is an illustrative drawing of the preferred embodiment of the method of the present invention.

### DETAILED DESCRIPTION

The present invention provides a method of efficiently ordering and distributing a plurality of electronic license keys that overcomes the disadvantages of existing methods. Rather than supplying license keys for individual computer appliances, the Selling Party provides purchasers with one or more “license tokens”. License tokens represent a right to access one or more specific software features. An appliance may have several optional features (Feature-A, Feature-B, etc.), and a single-feature license token (e.g., Token-A) may provide the right to enable only Feature-A, but not Feature-B or other features. A multi-feature license token may provide the right to enable several specified features. A license token may also be a multi-user license token. Such license tokens may be delegated to additional users, in one or several steps, and may be either single-feature license tokens or multi-feature license tokens.

For a purchaser's hierarchical organization, there may be many appliances at different levels of the organization, and certain access rights may be limited to particular levels. The Selling Party may supply a multi-feature, multi-user license token to the top level of the purchaser's organization. The token specifies which features may be enabled, and how many times each feature may be enabled by the purchaser. For example, the token may provide the right to enable 50 Feature-As and 100 Feature-Bs. The purchaser can forward tokens to different levels or parts of the purchaser's organization, or can load “node-locked” license keys on particular appliances that are not authorized to pass on the license to other users. In effect, the license token is passed on between consecutive appliances or users until it has been loaded on an end-user appliance.

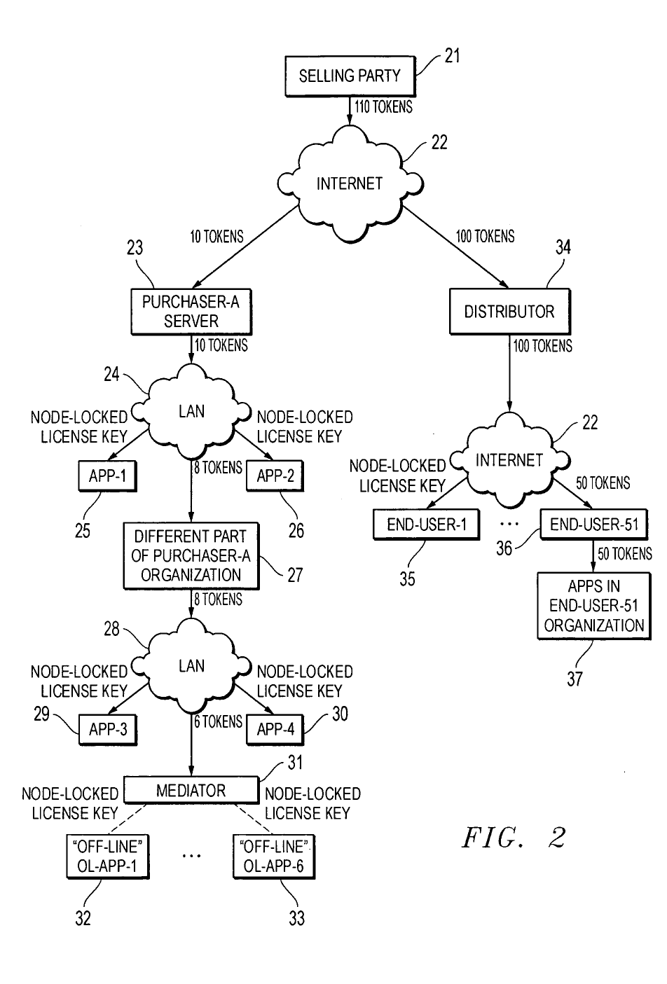

FIG. 2 is an illustrative drawing of the preferred embodiment of the method of the present invention. In practice, a number of license tokens may be downloaded from the Selling Party 21 through, for example the Internet 22, to a central point in the purchaser's organization, such as a server 23. Of course, tokens may also be distributed by other methods such as mail, fax, telephone, and the like. In the example illustrated in FIG. 2, ten (10) single-feature tokens are downloaded to Purchaser-A's server. Alternatively, this may also be a single-feature, multi-user token authorizing ten users to enable a particular feature. For simplicity, multiple rights are referred to herein as multiple tokens. From the server, Purchaser-A distributes license tokens within Purchaser-A's organization through, for example, a Local Area Network (LAN) 24. Tokens may be distributed directly to computer appliances such as App-1 25 and App-2 26. If these appliances are end-users, and thus are not authorized to further distribute the license rights, the encrypted key string is loaded into App-1 and App-2 as node-locked license keys.

Purchaser-A may also distribute a number of license tokens to the next level in Purchaser-A's hierarchical organization or to a different part of Purchaser-A's organization 27. In the example illustrated in FIG. 2, eight (8) tokens are distributed to the different part of Purchaser-A's organization. From there, the tokens may be further distributed through LAN 28 to individual appliances App-3 29 and App-4 30 (as node-locked license keys). A number of other tokens (6 tokens in FIG. 2) are downloaded to a portable “mediator” appliance (for example a laptop computer) 31, which can be later connected to “off-line” appliances OL-App-1 32 through OL-App-6 33 to load node-locked license keys. Thus, the transfer of license rights takes place without having to manually load the license keys, and without on-line contact with the preceding “token owner”. This methodology greatly simplifies the distribution of license rights in an organization.

A number of license tokens may also be downloaded from the Selling Party 21 to a Distributor 34 who then distributes the license tokens through, for example the Internet 22, to end-users 35 and 36. The Distributor may also sell appliances to end-users, and in this case, the Distributor may load a node-locked license key on the appliance prior to delivering the appliance, rather than distributing a token. The original number of tokens provided by the Selling Party (100 tokens in FIG. 2) can be subdivided into smaller numbers, thereby enabling further distribution of the rights. For example, end-user-1 35 may have a single appliance, and therefore, a single node-locked license key is downloaded to end-user-1. Alternatively, end-user-51 36 may have a large number of appliances needing licenses (50 in FIG. 2), and therefore, 50 license tokens are downloaded to end-user-51. In turn, end-user-51 then distributes license tokens and/or node-locked license keys to appliances 37 within end-user-51's organization.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of distributing an electronic license key from a selling party to a plurality of computer appliances, wherein loading the electronic license key on an appliance enables the appliance to access a protected software portion, said method comprising the steps of:
distributing a plurality of license tokens from the selling party to a user having a plurality of computer appliances that require the electronic license key, wherein each license token enables the user to load the electronic license key onto one of the computer appliances; and
loading the electronic license key by the user onto a plurality of computer appliances.

2. The method of claim 1, wherein the step of loading the electronic license key by the user includes loading the electronic license key onto a number of computer appliances that is less than or equal to the plurality of license tokens distributed from the selling party.

3. The method of claim 1, wherein the plurality of license tokens are received by the user in a first part of the user's organization, and the step of loading the electronic license key by the user includes:
dividing the plurality of license tokens received by the user into a first subset and a second subset;
loading the electronic license key onto a number of computer appliances within the first part of the user's organization that is equal to or less than the number of license tokens in the first subset;
forwarding the second subset of license tokens from the first part of the user's organization to a second part of the user's organization; and
loading the electronic license key onto a number of computer appliances within the second part of the user's organization that is equal to or less than the number of license tokens in the second subset.

4. The method of claim 1, wherein one of the user's computer appliances is an off-line appliance that is not connected to a network through which the electronic license key can be downloaded, and the step of loading the electronic license key by the user includes:
loading a subset of license tokens on a portable appliance;
connecting the portable appliance to the off-line appliance; and
loading the electronic license key onto the off-line appliance from the portable appliance.

5. The method of claim 1, further comprising the steps of:
distributing a plurality of license tokens from the selling party to a distributor;
dividing the plurality of license tokens received by the distributor into a first subset and a second subset;
sending the first subset of license tokens from the distributor to a first end-user; and
loading the electronic license key onto a number of computer appliances within the first end-user's organization that is equal to or less than the number of license tokens in the first subset.

6. The method of claim 5, further comprising the steps of:
sending the second subset of license tokens from the distributor to a second end-user; and
loading the electronic license key onto a number of computer appliances within the second end-user's organization that is equal to or less than the number of license tokens in the second subset.

7. A method of distributing an electronic license key to a plurality of computer appliances, wherein loading the electronic license key on an appliance enables the appliance to access a protected software portion, said method comprising the steps of:
receiving by a distributor, a plurality of license tokens distributed by a selling party, wherein each license token enables an end-user to load the electronic license key onto one of the end-user's computer appliances; and
sending at least one license token from the distributor to a first end-user.

8. The method of claim 7, further comprising loading the electronic license key onto a computer appliance by the first end-user.

9. The method of claim 7, wherein the step of sending at least one license token from the distributor to the first end-user includes:
dividing the plurality of license tokens received by the distributor into a first subset and a second subset; and
sending the first subset of license tokens from the distributor to the first end-user.

10. The method of claim 9, further comprising loading the electronic license key onto a number of computer appliances by the first end-user, said number of computer appliances being equal to or less than the number of license tokens in the first subset.

11. The method of claim 9, further comprising sending the second subset of license tokens from the distributor to a second end-user.

12. The method of claim 11, further comprising loading the electronic license key onto a number of computer appliances by the second end-user, said number of computer appliances being equal to or less than the number of license tokens in the second subset.

13. A method of distributing an electronic license key from a selling party to a plurality of computer appliances, wherein loading the electronic license key on an appliance enables the appliance to access a protected software portion, said method comprising the steps of:
sending a plurality of license tokens from the selling party to a user having a plurality of computer appliances that require the electronic license key, wherein each license token enables the user to load the electronic license key onto one of the computer appliances;
receiving the plurality of license tokens in a first part of the user's organization;
dividing the plurality of license tokens received by the user into a first subset and a second subset;
loading the electronic license key onto a number of computer appliances within the first part of the user's organization that is equal to or less than the number of license tokens in the first subset;
forwarding the second subset of license tokens from the first part of the user's organization to a second part of the user's organization; and
loading the electronic license key onto a number of computer appliances within the second part of the user's organization that is equal to or less than the number of license tokens in the second subset.

14. The method of claim 13, wherein one of the user's computer appliances is an off-line appliance that is not connected to a network through which the electronic license key can be downloaded, and the method further comprises:
loading a license token on a portable appliance;
connecting the portable appliance to the off-line appliance; and
loading the electronic license key onto the off-line appliance from the portable appliance.

15. A method of distributing an electronic license key from a selling party to a plurality of computer appliances, wherein loading the electronic license key on an appliance enables the appliance to access a protected software portion, said method comprising the steps of:
creating a license token that provides a user with a right to load the electronic license key onto the plurality of computer appliances; and
distributing the license token from the selling party to the user.

16. A method of distributing a plurality of electronic license keys from a selling party to a user having at least one computer appliance, wherein each electronic license key enables the appliance to access a different protected software feature, said method comprising the steps of:
creating a license token that provides the user with a right to load the plurality of electronic license keys onto the at least one computer appliance; and
distributing the license token from the selling party to the user.

17. The method of claim 16, wherein the step of creating the license token also includes creating a license token that enables the user to pass on the license token to a specified number of other users.

18. The method of claim 17, wherein the step of creating a license token that enables the user to pass on the license token to a specified number of other users includes creating a license token that enables the user to pass on a license token that provides another user with the right to load only a selected license key onto a computer appliance.
